(19) United States
(12) Patent Application Publication
(10) Pub. No.: US 2026/0269138 A1
(43) Pub. Date: Sep. 10, 2026

(54) MULTI-UNIT MULTILAYER CERAMIC CAPACITOR

(71) Applicant: Murata Manufacturing Co., Ltd., Nagaokakyo-shi (JP)

(72) Inventor: Kazunori USUI, Nagaokakyo-shi (JP)

(21) Appl. No.: 19/446,050

(22) Filed: Jan. 12, 2026

(30) Foreign Application Priority Data
Mar. 5, 2025 (JP) 2025-034794

(51) Int. Cl. H01G 4/38; H01G 4/012; H01G 4/12; H01G 4/232; H01G 4/30

(52) U.S. Cl. CPC H01G 4/38; H01G 4/012; H01G 4/12; H01G 4/2325; H01G 4/30

(57) ABSTRACT

A multi-unit multilayer ceramic capacitor includes, inside a single element assembly, capacitors each including dielectric layers and inner electrode layers, and positioned at predetermined intervals in length and lamination directions. The inner electrode layers include first inner electrode layers connected to a first outer electrode, and second inner electrode layers connected to a second outer electrode. Each of the first inner electrode layers includes a first counter electrode portion, and a first extended portion protruding toward the first outer electrode. Each of the second inner electrode layers includes a second counter electrode portion, and a second extended portion protruding toward the second outer electrode. A maximum dimension of the multilayer body in a height direction is larger than a dimension in the height direction at a ½ position in the lamination direction.

### CROSS REFERENCE TO RELATED APPLICATIONS

This application claims the benefit of priority to Japanese Patent Application No. 2025-034794 filed on Mar. 5, 2025. The entire contents of this application are hereby incorporated herein by reference.

### BACKGROUND OF THE INVENTION

### 1. Field of the Invention

The present invention relates to multi-unit multilayer ceramic capacitors.

### 2. Description of the Related Art

Along with improvement in performance of APUs (Accelerated Processing Units) to be used for smartphones, etc., impedance design has been more difficult to secure power supply stability during high-speed operation. Most common measures are to prepare a plurality of general two-terminal capacitors in which inner electrode layers are exposed on end surfaces, appropriately select the two-terminal capacitors depending on different frequency characteristics, and dispose the two-terminal capacitors in parallel on power supply lines, thereby reducing impedance over a wide band.

Japanese Unexamined Patent Application Publication No. 2019-179928 is an example of related art.

### SUMMARY OF THE INVENTION

However, there is concern that this method has problems of an increase in costs and a decrease in yields due to an increase in number of mounted components.

Therefore, example embodiments of the present invention provide multi-unit multilayer ceramic capacitors in each of which reduction in costs and improvement in yields are achieved and production efficiency is improved.

A multi-unit multilayer ceramic capacitor according to an example embodiment of the present invention includes a multilayer body including a first side surface and a second side surface that face each other in a lamination direction, a first principal surface and a second principal surface that face each other in a height direction perpendicular or substantially perpendicular to the lamination direction, and a first end surface and a second end surface that face each other in a length direction perpendicular or substantially perpendicular to both the lamination direction and the height direction, a first outer electrode extending in the lamination direction on the second principal surface, and a second outer electrode extending in the lamination direction on the second principal surface. The multilayer body includes, inside a single element assembly, a plurality of capacitor units each including a plurality of dielectric layers and a plurality of inner electrode layers. The plurality of capacitor units are positioned at predetermined intervals in the length direction and the lamination direction. The inner electrode layers include first inner electrode layers connected to the first outer electrode, and second inner electrode layers connected to the second outer electrode. Each of the first inner electrode layers includes a first counter electrode portion, and a first extended portion protruding toward the first outer electrode. Each of the second inner electrode layers includes a second counter electrode portion, and a second extended portion protruding toward the second outer electrode. A maximum dimension of the multilayer body in the height direction is larger than a dimension in the height direction at a ½ position in the lamination direction.

In a multi-unit multilayer ceramic capacitor according to an example embodiments of the present invention, the multilayer body includes, inside the single element assembly, the plurality of capacitor units each including the plurality of dielectric layers and the plurality of inner electrode layers. The plurality of capacitor units are positioned at predetermined intervals in the length direction and the lamination direction. The inner electrode layers include the first inner electrode layers connected to the first outer electrode, and the second inner electrode layers connected to the second outer electrode. Each of the first inner electrode layers includes the first counter electrode portion, and the first extended portion protruding toward the first outer electrode. Each of the second inner electrode layers includes the second counter electrode portion, and the second extended portion protruding toward the second outer electrode. Thus, the current path can be shortened, and therefore ESL (Equivalent Series Inductance) can be reduced compared with a general two-terminal capacitor in which inner electrode layers are exposed on both end surfaces. In addition, the plurality of two-terminal capacitors can be replaced only with the multi-unit multilayer ceramic capacitor. Further, the number of capacitor units included inside the multilayer body of the multi-unit multilayer ceramic capacitor is adjusted depending on the arrangement of land electrodes. Therefore, the arrangement of the land electrodes for the general two-terminal capacitors can be used as it is without changing design.

In a multi-unit multilayer ceramic capacitor according to an example embodiment of the present invention, the maximum dimension of the multilayer body in the height direction is larger than the dimension in the height direction at the ½ position in the lamination direction. Thus, two sides of the second principal surface protrude, and therefore the posture stability can be improved during mounting. With this structure, during resin sealing with a mold resin, a gap is present at the lower surface of the multilayer body. Therefore, the mold resin can easily enter the gap at the lower surface of the multilayer body, and the fixing force between the mold resin and the multi-unit multilayer ceramic capacitor can be improved.

According to example embodiments of the present invention, it is possible to provide multi-unit multilayer ceramic capacitors in each of which reduction in costs and improvement in yields are achieved and production efficiency can be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating a multi-unit multilayer ceramic capacitor according to an example embodiment of the present invention.

FIG. 2 is a bottom view illustrating an example of a multi-unit multilayer ceramic capacitor according to an example embodiment of the present invention.

FIG. 3 is a left-hand side view illustrating an example of a multi-unit multilayer ceramic capacitor according to an example embodiment of the present invention.

FIG. 4 is a schematic cross-sectional view taken along line IV-IV in FIG. 1.

FIG. 5 is a schematic cross-sectional view taken along line V-V in FIG. 1.

FIG. 6 is a schematic cross-sectional view taken along line VI-VI in FIG. 3.

FIG. 7 is a schematic cross-sectional view taken along line VII-VII in FIG. 3.

FIG. 8 is a see-through perspective view illustrating disposition of inner electrode layers inside a multilayer body of a multi-unit multilayer ceramic capacitor according to an example embodiment of the present invention.

FIG. 9 is a see-through perspective view illustrating disposition of exposed portions of the inner electrode layers inside of a multilayer body of a multi-unit multilayer ceramic capacitor according to an example embodiment of the present invention.

FIG. 10 is an exploded perspective view of a multilayer body of a multi-unit multilayer ceramic capacitor according to an example embodiment of the present invention.

### DETAILED DESCRIPTION OF THE EXAMPLE EMBODIMENTS

Examples of multi-unit multilayer ceramic capacitors 10 according to example embodiments of the present invention are described below.

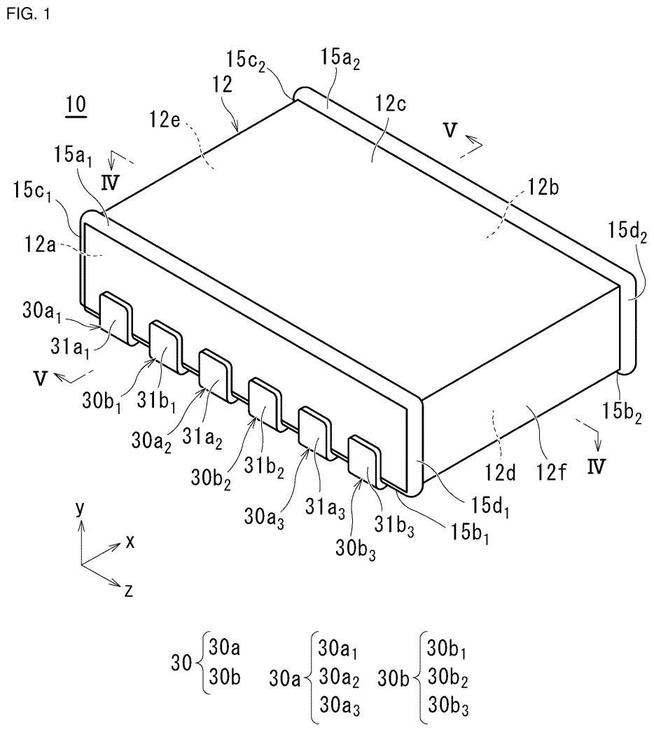

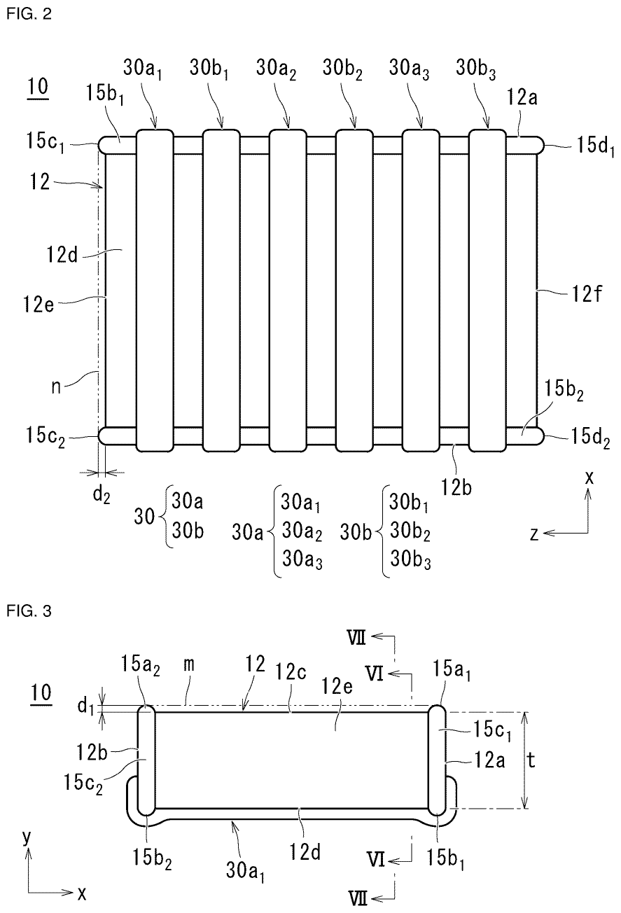

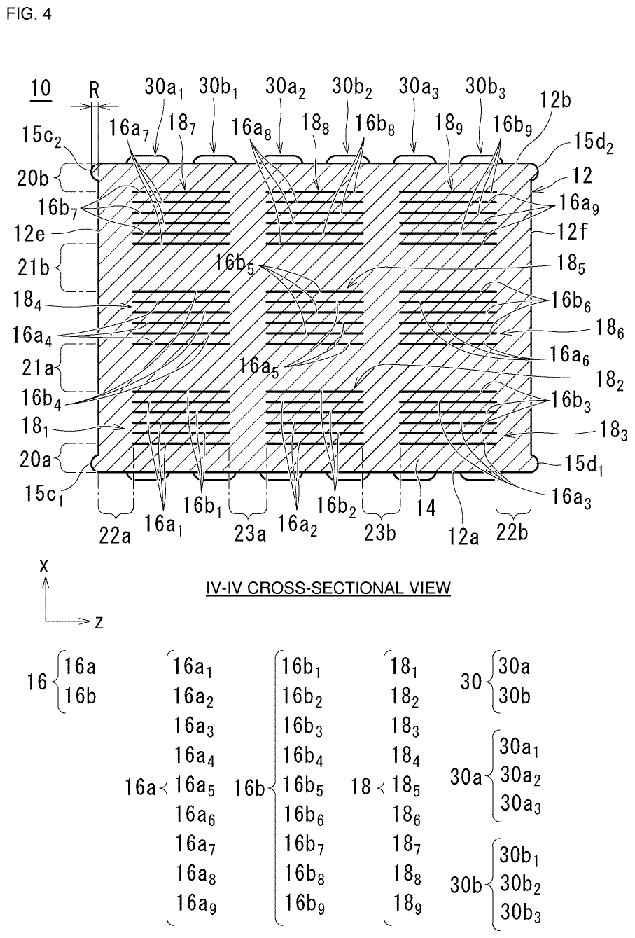

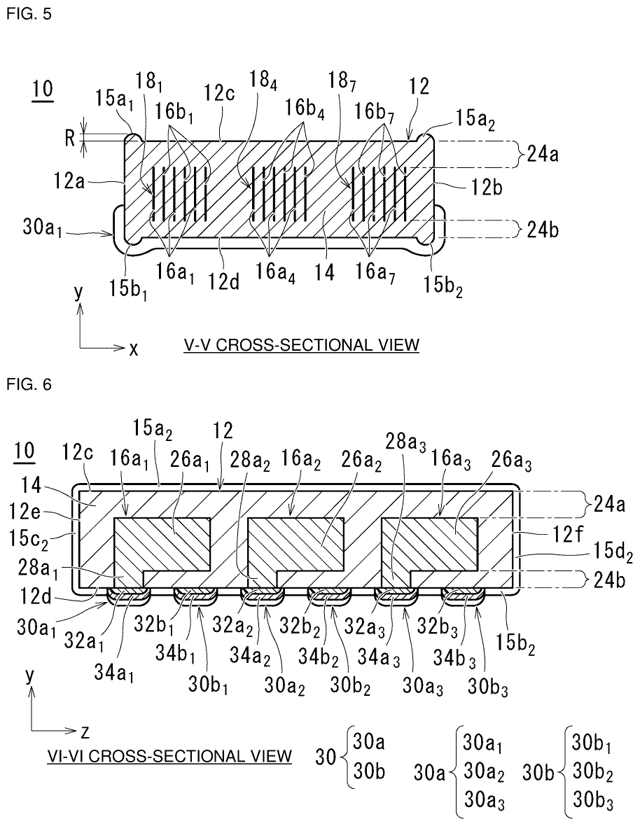

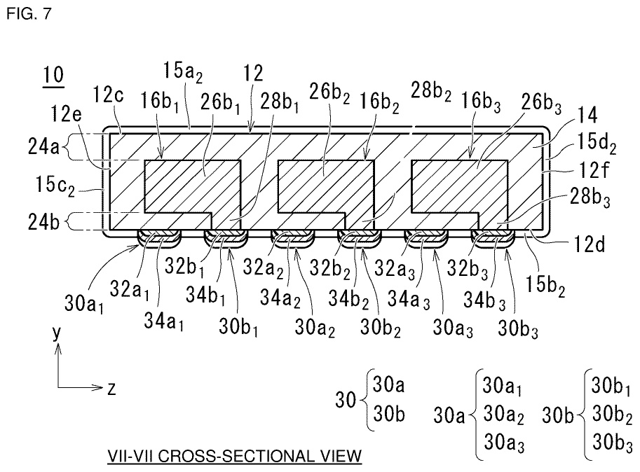

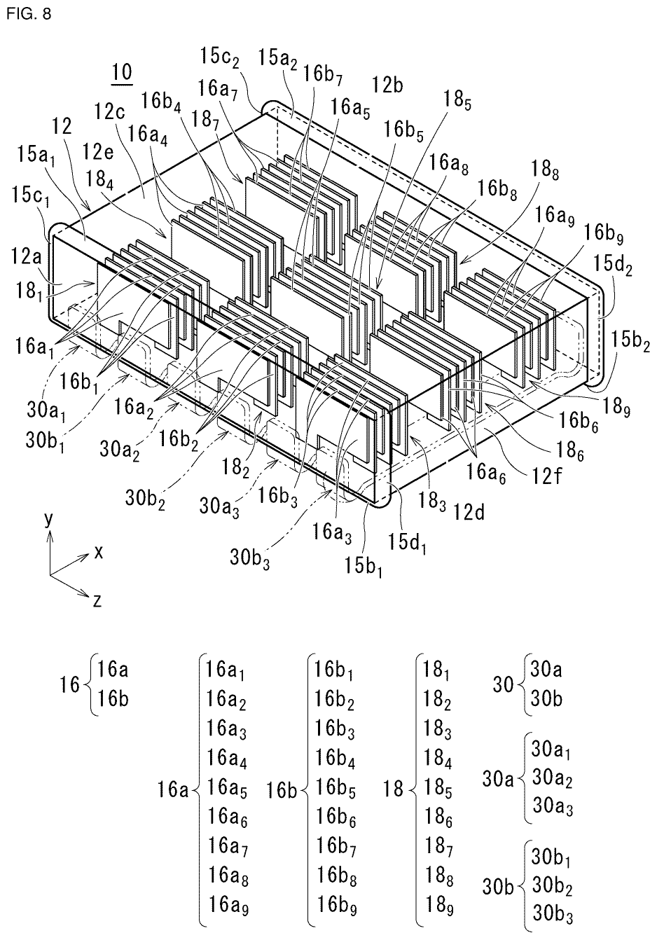

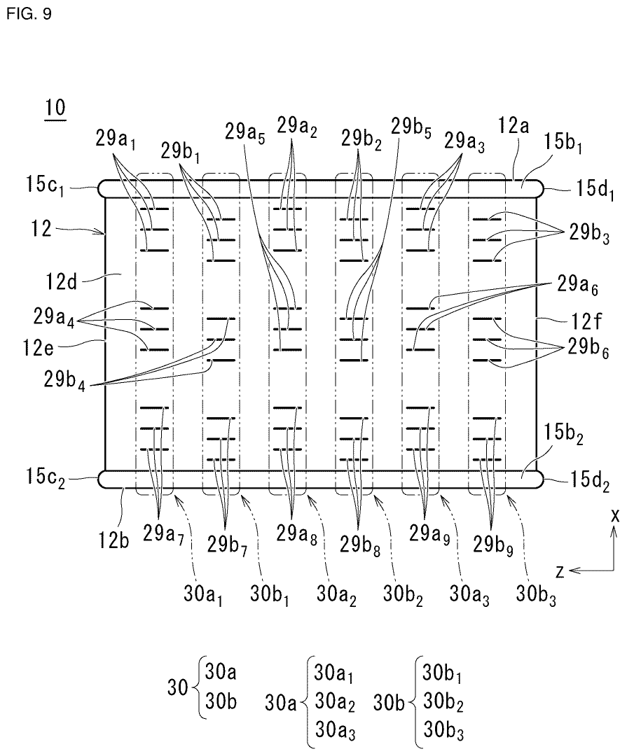

FIG. 1 is an external perspective view illustrating the multi-unit multilayer ceramic capacitor according to an example embodiment of the present invention. FIG. 2 is a bottom view illustrating an example of a multi-unit multilayer ceramic capacitor according to an example embodiment of the present invention. FIG. 3 is a left-hand side view illustrating an example of a multi-unit multilayer ceramic capacitor according to an example embodiment of the present invention. FIG. 4 is a schematic cross-sectional view taken along line IV-IV in FIG. 1. FIG. 5 is a schematic cross-sectional view taken along line V-V in FIG. 1. FIG. 6 is a schematic cross-sectional view taken along line VI-VI in FIG. 3. FIG. 7 is a schematic cross-sectional view taken along line VII-VII in FIG. 3. FIG. 8 is a see-through perspective view illustrating disposition of inner electrode layers inside a multilayer body of a multi-unit multilayer ceramic capacitor according to an example embodiment of the present invention. FIG. 9 is a see-through perspective view illustrating disposition of exposed portions of the inner electrode layers inside a multilayer body of a multi-unit multilayer ceramic capacitor according to an example embodiment of the present invention.

As illustrated in FIG. 1 and FIG. 2, the multi-unit multilayer ceramic capacitor 10 includes, for example, a multilayer body 12 and outer electrodes 30.

The multilayer body 12 includes a plurality of laminated dielectric layers 14 and a plurality of inner electrode layers 16 laminated on the dielectric layers 14. The inner electrode layers 16 include first inner electrode layers 16a and second inner electrodes layer 16b. Details of the first inner electrode layers 16a and the second inner electrode layers 16b are described later.

The multilayer body 12 includes a first side surface 12a and a second side surface 12b that face each other in a lamination direction x, a first principal surface 12c and a second principal surface 12d that face each other in a height direction y perpendicular or substantially perpendicular to the lamination direction x, and a first end surface 12e and a second end surface 12f that face each other in a length direction z perpendicular or substantially perpendicular to the lamination direction x and the height direction y. The second principal surface 12d is a surface adjacent to a mounting surface.

The multilayer body 12 includes, inside a single element assembly, a capacitor unit 18 including a plurality of dielectric layers 14 and a plurality of inner electrode layers 16. Inside the multilayer body 12, a plurality of capacitor units 18 are positioned at predetermined intervals in the length direction z and the lamination direction x. In this example embodiment, the capacitor units 18 include nine capacitor units that are a first capacitor unit 18₁ to a ninth capacitor unit 18₉, for example.

The capacitor units 18 are preferably positioned inside the multilayer body 12 to satisfy a condition of 1≤N≤12 and 2≤M≤12 or 2≤N≤12 and 1≤M≤12, provided that N capacitor units 18 are positioned at predetermined intervals in the length direction z and M capacitor units 18 are positioned at predetermined intervals in the lamination direction x.

The multilayer body 12 has a rectangular or substantially rectangular parallelepiped shape. The corner portions and the ridge portions of the multilayer body 12 are preferably rounded. The corner portion is a portion where three surfaces of the multilayer body 12 intersect each other. The ridge portion is a portion where two surfaces of the multilayer body 12 intersect each other. A portion or an entirety of the first side surface 12a and the second side surface 12b, the first principal surface 12c and the second principal surface 12d, and the first end surface 12e and the second end surface 12f may have irregularities, etc.

A dimension t of the multilayer body 12 in the height direction y is preferably about 1.00 mm or less, for example.

As illustrated in FIG. 4, the multilayer body 12 includes, in the lamination direction x, the plurality of capacitor units 18, a first outer layer portion 20a located between the first side surface 12a and the capacitor units 18 (18₁ to 18₃) closest to the first side surface 12a among the plurality of capacitor units 18, a second outer layer portion 20b located between the second side surface 12b and the capacitor units 18 (18₇ to 18₉) closest to the second side surface 12b among the plurality of capacitor units 18, and intermediate layers 21 located between the capacitor units 18. The intermediate layer 21 is ten times or more as thick as the dielectric layer 14 of the capacitor unit 18. In this example embodiment, the intermediate layers 21 include a first intermediate layer 21a located between the capacitor units 18₁ to 18₃ and the capacitor units 18₄ to 18₆, and a second intermediate layer 21b located between the capacitor units 18₄ to 18₆ and the capacitor units 18₇ to 18₉.

As illustrated in FIG. 4, the multilayer body 12 includes, in the length direction z, a first end gap 22a located between the capacitor units 18 (18₁, 18₄, 18₇) and the first end surface 12e, a second end gap 22b located between the capacitor units 18 (18₃, 18₆, 18₉) and the second end surface 12f, and intermediate gaps 23 located between the capacitor units 18. In this example embodiment, the intermediate gaps 23 include a first intermediate gap 23a located between the capacitor units 18₁, 18₄, 18₇ and the capacitor units 18₂, 18₅, 18₈, and a second intermediate gap 23b located between the capacitor units 18₂, 18₅, 18₈ and the capacitor units 18₃, 18₆, 18₉.

As illustrated in FIG. 5 to FIG. 7, the multilayer body 12 includes, in the height direction y, an upper region 24a located between the capacitor units 18 and the first principal surface 12c, and a lower region 24b located between the capacitor units 18 and the second principal surface 12d.

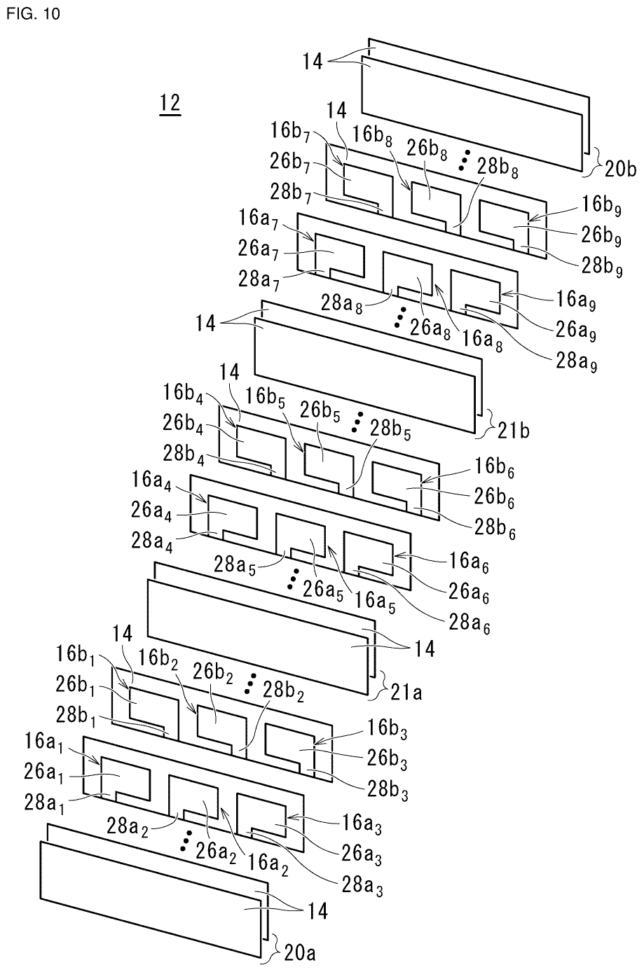

As illustrated in FIG. 4 and FIG. 10, the first outer layer portion 20a is located adjacent to the first side surface 12a of the multilayer body 12, and is an aggregate of a plurality of dielectric layers 14 located between the first side surface 12a and the capacitor units 18 (18₁ to 18₃) closest to the first side surface 12a. The second outer layer portion 20b is located adjacent to the second side surface 12b of the multilayer body 12, and is an aggregate of a plurality of dielectric layers 14 located between the second side surface 12b and the capacitor units 18 (18₇ to 18₉) closest to the second side surface 12b.

The maximum dimension of the multilayer body 12 in the height direction y is larger than the dimension in the height direction y at a ½ position in the lamination direction x. With the above structure, the posture of the multi-unit multilayer ceramic capacitor 10 can be stabilized during mounting. When the multi-unit multilayer ceramic capacitor 10 is mounted on a mounting board and then molded with a mold resin, the mold resin can easily enter a gap between the mounting board and the second principal surface 12d of the multilayer body 12, and the fixing force of the mold resin to the multi-unit multilayer ceramic capacitor 10 can be improved.

The first principal surface 12c preferably includes a protrusion 15a1 that protrudes in the height direction y along the end edge adjacent to the first side surface 12a from the first end surface 12e to the second end surface 12f. The first principal surface 12c preferably includes a protrusion 15a2 that protrudes in the height direction y along the end edge adjacent to the second side surface 12b from the first end surface 12e to the second end surface 12f. Thus, the first principal surface 12c is recessed when viewed from the second end surface 12f.

Similarly, the second principal surface 12d preferably includes a protrusion 15b1 that protrudes in the height direction y along the end edge adjacent to the first side surface 12a from the first end surface 12e to the second end surface 12f. The second principal surface 12d preferably includes a protrusion 15b2 that protrudes in the height direction y along the end edge adjacent to the second side surface 12b from the first end surface 12e to the second end surface 12f. Thus, the second principal surface 12d is recessed when viewed from the second end surface 12f.

When at least the second principal surface 12d has the protrusion 15b1 and the protrusion 15b2 as described above, the posture of the multi-unit multilayer ceramic capacitor 10 can further be stabilized during mounting. When the multi-unit multilayer ceramic capacitor 10 is mounted on the mounting board and then molded with the mold resin, the mold resin can easily enter the gap between the mounting board and the second principal surface 12d of the multilayer body 12, and the fixing force of the mold resin to the multi-unit multilayer ceramic capacitor 10 can further be improved.

When the first principal surface 12c is viewed from the first end surface 12e, a distance d₁ between a point at the ½ position in the lamination direction x and a line m connecting the maximum point of the protrusion 15a1 provided to the end edge adjacent to the first side surface 12a and the maximum point of the protrusion 15a2 provided to the end edge adjacent to the second side surface 12b is preferably about 2 μm or more, for example.

Similarly, when the second principal surface 12d is viewed from the first end surface 12e, a distance between a point at the ½ position in the lamination direction x and a line connecting the maximum point of the protrusion 15b1 provided to the end edge adjacent to the first side surface 12a and the maximum point of the protrusion 15b2 provided to the end edge adjacent to the second side surface 12b is preferably about 2 μm or more, for example.

When at least the second principal surface 12d includes the protrusion 15b1 and the protrusion 15b2 as described above, the posture of the multi-unit multilayer ceramic capacitor 10 can further be stabilized during mounting. When the multi-unit multilayer ceramic capacitor 10 is mounted on the mounting board and then molded with the mold resin, the mold resin can easily enter the gap between the mounting board and the second principal surface 12d of the multilayer body 12, and the fixing force of the mold resin to the multi-unit multilayer ceramic capacitor 10 can further be improved.

The maximum dimension of the multilayer body 12 in the length direction z is larger than the dimension in the length direction z at the ½ position in the lamination direction x, for example. With this structure, the contact area between the mold resin and the multilayer body 12 increases during resin sealing with the mold resin, and therefore the fixing force of the mold resin to the multi-unit multilayer ceramic capacitor 10 can be improved.

The first end surface 12e includes a protrusion 15c1 that protrudes in the length direction z along the end edge adjacent to the first side surface 12a from the first principal surface 12c to the second principal surface 12d. The first end surface 12e includes a protrusion 15c2 that protrudes in the length direction z along the end edge adjacent to the second side surface 12b from the first principal surface 12c to the second principal surface 12d. Thus, the first end surface 12e is recessed when viewed from the second principal surface 12d.

Similarly, the second end surface 12f includes a protrusion 15d1 that protrudes in the length direction z along the end edge adjacent to the first side surface 12a from the first principal surface 12c to the second principal surface 12d. The second end surface 12f includes a protrusion 15d2 that protrudes in the length direction z along the end edge adjacent to the second side surface 12b from the first principal surface 12c to the second principal surface 12d. Thus, the second end surface 12f is recessed when viewed from the second principal surface 12d.

With the above structure, the contact area between the mold resin and the multilayer body 12 increases during resin sealing with the mold resin, and therefore the fixing force of the mold resin to the multi-unit multilayer ceramic capacitor 10 can further be improved.

When the first end surface 12e is viewed from the second principal surface 12d, a distance d₂ between a point at the ½ position in the lamination direction x and a line n connecting the maximum point of the protrusion 15c₁ provided to the end edge adjacent to the first side surface 12a and the maximum point of the protrusion 15c₂ provided to the end edge adjacent to the second side surface 12b is preferably about 2 μm or more, for example.

Similarly, when the second end surface 12f is viewed from the second principal surface 12d, a distance between a point at the ½ position in the lamination direction x and a line connecting the maximum point of the protrusion 15d₁ provided to the end edge adjacent to the first side surface 12a and the maximum point of the protrusion 15d₂ provided to the end edge adjacent to the second side surface 12b is preferably about 2 μm or more, for example.

With the above structure, the contact area between the mold resin and the multilayer body 12 increases during resin sealing with the mold resin, and therefore the fixing force of the mold resin to the multi-unit multilayer ceramic capacitor 10 can further be improved.

A roundness amount that is the curvature radius of each of the protrusions 15a₁ to 15d₂ of the multilayer body 12 illustrated in FIG. 4 and FIG. 5 is preferably about 10 μm or more and about 200 μm or less, for example. Thus, chipping or cracking of the multilayer body 12 is reduced or prevented, and therefore the reliability of the multi-unit multilayer ceramic capacitor 10 can be improved.

The dielectric layer 14 may be made of a ceramic material such as dielectric ceramics including BaTiO₃, CaTiO₃, SrTiO₃, or CaZro₃ as a component. A material obtained by adding an auxiliary component such as a Mn compound, an Fe compound, a Cr compound, a Co compound, or a Ni compound to the main component may be used.

The thickness of the dielectric layer 14 is preferably about 0.3 μm or more and about 1.0 μm or less, for example. The number of laminated dielectric layers 14 included in one capacitor unit 18 is preferably four or more and 1000 or less, for example.

The inner electrode layers 16 include the first inner electrode layers 16a and the second inner electrode layers 16b.

As illustrated in FIG. 4 and FIG. 6, the first inner electrode layers 16a include a plurality of first inner electrode layers 16a₁ to 16a₃ included in the first capacitor unit 18₁ to the third capacitor unit 18₃, a plurality of first inner electrode layers 16a₄ to 16a₆ included in the fourth capacitor unit 18₄ to the sixth capacitor unit 18₆, and a plurality of first inner electrode layers 16a₇ to 16a₈ included in the seventh capacitor unit 18₇ to the ninth capacitor unit 18₉. The first inner electrode layers 16a₁ to 16a₃ are disposed on the same dielectric layer 14. The first inner electrode layers 16a₄ to 16a₆ are disposed on the same dielectric layer 14. The first inner electrode layers 16a₇ to 16a₉ are disposed on the same dielectric layer 14. The first inner electrode layer 16a is extended to the second principal surface 12d.

The first inner electrode layers 16a are described in detail taking the first inner electrode layer 16a₁ as an example. As illustrated in FIG. 6, the first inner electrode layer 16a₁ includes a first counter electrode portion 26a₁ that faces a second inner electrode layer 16b₁, and a first extended portion 28a₁ that extends from the first counter electrode portion 26a₁ and is extended to the second principal surface 12d. The first extended portion 28a₁ includes a first exposed portion 29a₁ exposed on the second principal surface 12d of the multilayer body 12. The shape of the first counter electrode portion 26a₁ and the shape of the first extended portion 28a₁ are not particularly limited, but each shape preferably is a rectangular or substantially rectangular shape. The corner portion of the first counter electrode portion 26a₁ may be rounded.

The first inner electrode layers 16a₂ to 16a₉ have the same structure as the first inner electrode layer 16a₁.

As illustrated in FIG. 4 and FIG. 7, the second inner electrode layers 16b include a plurality of second inner electrode layers 16b₁ to 16b₃ included in the first capacitor unit 18₁ to the third capacitor unit 18₃, a plurality of second inner electrode layers 16b₄ to 16b₆ included in the fourth capacitor unit 18₄ to the sixth capacitor unit 18₆, and a plurality of second inner electrode layers 16b₇ to 16b₉ included in the seventh capacitor unit 18₇ to the ninth capacitor unit 18₉. The second inner electrode layers 16b₁ to 16b₃ are disposed on the same dielectric layer 14. The second inner electrode layers 16b₄ to 16b₆ are disposed on the same dielectric layer 14. The second inner electrode layers 16b₇ to 16b₉ are disposed on the same dielectric layer 14. The second inner electrode layer 16b is extended to the second principal surface 12d.

The second inner electrode layers 16b are described in detail taking the second inner electrode layer 16b₁ as an example. As illustrated in FIG. 7, the second inner electrode layer 16b₁ includes a second counter electrode portion 26b₁ that faces the first inner electrode layer 16a₁, and a second extended portion 28b₁ that extends from the second counter electrode portion 26b₁ and is extended to the second principal surface 12d. The second extended portion 28b₁ includes a second exposed portion 29b₁ exposed on the second principal surface 12d of the multilayer body 12. The shape of the second counter electrode portion 26b₁ and the shape of the second extended portion 28b₁ are not particularly limited, but are each preferably a rectangular shape. The corner portion of the second counter electrode portion 26b₁ may be rounded.

The second inner electrode layers 16b₂ to 16b₉ have the same structure as the second inner electrode layer 16b₁.

In the first capacitor unit 18₁, the first counter electrode portion 26a₁ of the first inner electrode layer 16a₁ and the second counter electrode portion 26b₁ of the second inner electrode layer 16b₁ face each other. In this example embodiment, the first counter electrode portion 26a₁ of the first inner electrode layer 16a₁ and the second counter electrode portion 26b₁ of the second inner electrode layer 16b₁ face each other via the dielectric layer 14 to form an electrostatic capacitance and exhibit capacitor characteristics.

The second to ninth capacitor units 18₂ to 18₉ have the same structure as the first capacitor unit 18₁ to exhibit capacitor characteristics.

A Sn layer is located between the dielectric layer 14 and each of the first inner electrode layer 16a and the second inner electrode layer 16b. Therefore, electric field concentration on the interface between the inner electrode layer 16 and the dielectric layer 14 can be reduced, leading to improvement in high-temperature load reliability.

Each of the first inner electrode layer 16a and the second inner electrode layer 16b can be made of any appropriate conductive material such as a metal as typified by Ni, Cu, Ag, Pd, or Au or an alloy including at least one of these metals as typified by Ag—Pd alloy.

The number of laminated first inner electrode layers 16a included in one capacitor unit 18 is not particularly limited, but is preferably, for example, one or more and 250 or less. The number of laminated second inner electrode layers 16b included in one capacitor unit 18 is not particularly limited, but is preferably, for example, one or more and 250 or less. Thus, the total number of laminated first inner electrode layers 16a and second inner electrode layers 16b included in one capacitor unit 18 is preferably two or more and 500 or less.

The thickness of the first inner electrode layer 16a is not particularly limited, but is preferably, for example, about 0.3 μm or more and about 1.0 μm or less. The thickness of the second inner electrode layer 16b is not particularly limited, but is preferably, for example, about 0.3 μm or more and about 1.0 μm or less.

With the structure of the inner electrode layer 16 that is extended toward the second principal surface 12d (toward the mounting surface), the current path can be shortened, and ESL (Equivalent Series Inductance) can be reduced compared with a general two-terminal capacitor in which inner electrode layers are exposed on both end surfaces.

The plurality of two-terminal capacitors can be replaced with the multi-unit multilayer ceramic capacitor 10 in which the plurality of capacitor units are disposed in the multilayer body 12.

The outer electrodes 30 include first outer electrodes 30a and second outer electrodes 30b.

The first outer electrodes 30a include a plurality of first outer electrodes 30a₁ to 30a₃. The plurality of first outer electrodes 30a₁ to 30a₃ are disposed on the second principal surface 12d at predetermined intervals along the length direction z. The plurality of first outer electrodes 30a₁ to 30a₃ are disposed to extend in the lamination direction x.

The first outer electrode 30a₁ is electrically connected to the first exposed portions 29a₁, 29a₄, and 29a₇ of the first inner electrode layers 16a₁, 16a₄, and 16a₇. The first outer electrode 30a₁ is disposed to cover the first exposed portions 29a₁, 29a₄, and 29a₇ of the first inner electrode layers 16a₁, 16a₄, and 16a₇ that are exposed on the second principal surface 12d. The first outer electrode 30a₁ may include first folded portions 31a₁ located also on a portion of the first side surface 12a and a portion of the second side surface 12b.

The first outer electrode 30a₂ is electrically connected to the first exposed portions 29a₂, 29a₅, and 29a₅ of the first inner electrode layers 16a₂, and 16a₈. The first outer electrode 30a₂ is disposed to cover the first exposed portions 29a₂, 29a₅, and 29a₈ of the first inner electrode layers 16a₂, 16a₅, and 16a₈ that are exposed on the second principal surface 12d. The first outer electrode 30a₂ may include first folded portions 31a₂ located also on a portion of the first side surface 12a and a portion of the second side surface 12b.

The first outer electrode 30a₃ is electrically connected to the first exposed portions 29a₃, 29a₆, and 29a₉ of the first inner electrode layers 16a₃, 16a₆, and 16a₉. The first outer electrode 30a₃ is disposed to cover the first exposed portions 29a₃, 29a₆, and 29a₉ of the first inner electrode layers 16a₃, 16a₆, and 16a₉ that are exposed on the second principal surface 12d. The first outer electrode 30a₃ may have first folded portions 31a₃ disposed also on a portion of the first side surface 12a and a portion of the second side surface 12b.

The second outer electrodes 30b include a plurality of second outer electrodes 30b₁ to 30b₃. The plurality of second outer electrodes 30b₁ to 30b₃ are disposed on the second principal surface 12d at predetermined intervals along the length direction z. The plurality of second outer electrodes 30b₁ to 30b₃ are disposed to extend in the lamination direction x.

The second outer electrode 30b₁ is electrically connected to the second exposed portions 29b₁, 29b₄, and 29b₇ of the second inner electrode layers 16b₁, 16b₄, and 16b₇. The second outer electrode 30b₁ is disposed to cover the second exposed portions 29b₁, 29b₄, and 29b₇ of the second inner electrode layers 16b₁, 16b₄, and 16b₇ that are exposed on the second principal surface 12d. The second outer electrode 30b₁ may include second folded portions 31b₁ located also on a portion of the first side surface 12a and a portion of the second side surface 12b.

The second outer electrode 30b₂ is electrically connected to the second exposed portions 29b₂, 29b₅, and 29bs of the second inner electrode layers 16b₂, 16b₅, and 16b₈. The second outer electrode 30b₂ is disposed to cover the second exposed portions 29b₂, 29b₅, and 29b₉ of the second inner electrode layers 16b₂, 16b₅, and 16b₉ that are exposed on the second principal surface 12d. The second outer electrode 30b₂ may include second folded portions 31b₂ located also on a portion of the first side surface 12a and a portion of the second side surface 12b.

The second outer electrode 30b₃ is electrically connected to the second exposed portions 29b₃, 29b₆, and 29b₉ of the second inner electrode layers 16b₃, 16b₆, and 16b₉. The second outer electrode 30b₃ is disposed to cover the second exposed portions 29b₃, 29b₆, and 29b₉ of the second inner electrode layers 16b₃, 16b₆, and 16b₉ that are exposed on the second principal surface 12d. The second outer electrode 30b₃ may have second folded portions 31b₃ disposed also on a portion of the first side surface 12a and a portion of the second side surface 12b.

The outer electrodes 30 include underlying electrode layers 32 disposed on the surface of the multilayer body 12, and plating layers 34 disposed to cover the underlying electrode layers 32.

The underlying electrode layers 32 include first underlying electrode layers 32a and second underlying electrode layers 32b.

The plating layers 34 include first plating layers 34a and second plating layers 34b.

In other words, the first outer electrodes 30a include the first underlying electrode layers 32a and the first plating layers 34a. More specifically, the first outer electrodes 30a₁ to 30a₃ include first underlying electrode layers 32a₁ to 32a₃ and first plating layers 34a₁ to 34a₃.

The second outer electrodes 30b include the second underlying electrode layers 32b and the second plating layers 34b. More specifically, the second outer electrodes 30b₁ to 30b₃ include second underlying electrode layers 32b₁ to 32b₃ and second plating layers 34b₁ to 34b₃.

The first underlying electrode layers 32a₁ to 32a₃ are disposed on the second principal surface 12d of the multilayer body 12 and extending from the second principal surface 12d and cover a portion of the first side surface 12a and a portion of the second side surface 12b.

The second underlying electrode layers 32b₁ to 32b₃ are disposed on the second principal surface 12d of the multilayer body 12 and extending from the second principal surface 12d and cover a portion of the first side surface 12a and a portion of the second side surface 12b.

The underlying electrode layer 32 includes at least one selected from among a baked layer, a conductive resin layer, a thin film layer, etc.

Description is now made about each structure in the case where the underlying electrode layer 32 is the baked layer, the conductive resin layer, or the thin film layer described above.

The baked layer includes a glass component and a metal component. The glass component of the baked layer includes at least one selected from among B, Si, Ba, Mg, Al, Li, etc. The metal component of the baked layer includes at least one selected from among, for example, Cu, Ni, Ag, Pd, Ag—Pd alloy, and Au. The baked layer may be a plurality of layers. The baked layer is obtained by applying a conductive paste including the glass component and the metal component to the multilayer body 12 and baking the conductive paste. The baked layer may be obtained by simultaneously baking a multilayer chip including the inner electrode layers 16 and the dielectric layers 14 and a conductive paste applied to the multilayer chip, or may be obtained by baking a multilayer chip including the inner electrode layers 16 and the dielectric layers 14 to obtain the multilayer body 12, applying a conductive paste to the multilayer body 12, and baking the conductive paste. When the baked layer is obtained by simultaneously baking a multilayer chip including the inner electrode layers 16 and the dielectric layers 14 and a conductive paste applied to the multilayer chip, the baked layer is preferably formed by baking a material including a dielectric material added instead of the glass component.

In each of the first underlying electrode layers 32a₁ to 32a₃ located on the second principal surface 12d, the thickness in the height direction y connecting the first principal surface 12c and the second principal surface 12d is preferably about 10 μm or more and about 30 μm or less, for example.

In each of the second underlying electrode layers 32b₁ to 32b₃ located on the second principal surface 12d, the thickness in the height direction y connecting the first principal surface 12c and the second principal surface 12d is preferably about 10 μm or more and about 30 μm or less, for example.

In each of the first folded portions 31a₁ to 31a₃ of the first underlying electrode layers 32a₁ to 32a₃ located on a portion of the first side surface 12a and a portion of the second side surface 12b, the thickness in the lamination direction x connecting the first side surface 12a and the second side surface 12b at a central portion in the height direction y connecting the first principal surface 12c and the second principal surface 12d is preferably, for example, about 1 μm or more and about 20 μm or less.

In each of the second folded portions 31b₁ to 31b₃ of the second underlying electrode layers 32b₁ to 32b₃ located on a portion of the first side surface 12a and a portion of the second side surface 12b, the thickness in the lamination direction x connecting the first side surface 12a and the second side surface 12b at a central portion in the height direction y connecting the first principal surface 12c and the second principal surface 12d is preferably, for example, about 1 μm or more and about 20 μm or less.

The conductive resin layer may be disposed on a baked layer to cover the baked layer, or disposed directly on the multilayer body 12 without the baked layer. The conductive resin layer may completely cover the baked layer, or cover a portion of the baked layer. The conductive resin layer may include a plurality of layers.

The conductive resin layer includes a thermosetting resin and a metal. Since the conductive resin layer includes the thermosetting resin, the conductive resin layer has higher flexibility than, for example, a plating layer or a baked layer that is a baked product of a conductive paste. Therefore, when the multi-unit multilayer ceramic capacitor 10 receives a physical impact or an impact caused by a heat cycle, the conductive resin layer functions as a cushioning layer, and cracking of the multi-unit multilayer ceramic capacitor 10 can be prevented.

The metal included in the conductive resin layer may be Ag, Cu, Ni, Sn, Bi, or an alloy including any of these metals. A metal powder coated with Ag on its surface may be used. When the metal powder coated with Ag on its surface is used, the metal powder is preferably a powder of Cu, Ni, Sn, Bi, or an alloy thereof. The reasons why the conductive metal powder of Ag is used as the conductive metal are as follows. Ag is suitable as the electrode material because the specific resistance is lowest among the metals. Ag is not oxidized and weather resistance is high because Ag is the noble metal. An inexpensive base metal can be used while maintaining the above Ag characteristics.

The metal included in the conductive resin layer may be Cu or Ni subjected to antioxidation treatment. The metal included in the conductive resin layer may be a metal powder coated with Sn, Ni, or Cu on its surface. When the metal powder coated with Sn, Ni, or Cu on its surface is used, the metal powder is preferably a powder of Ag, Cu, Ni, Sn, Bi, or an alloy thereof.

The metal included in the conductive resin layer mainly provides conductivity to the conductive resin layer. Specifically, a conductive path is provided in the conductive resin layer by contact between conductive fillers.

The metal included in the conductive resin layer may have a spherical shape, a flat shape, etc., but is preferably a mixture of a spherical metal powder and a flat metal powder.

The resin in the conductive resin layer may be various known thermosetting resins such as an epoxy resin, a phenol resin, a urethane resin, a silicone resin, and a polyimide resin. Among others, the epoxy resin excellent in heat resistance, moisture resistance, adhesion, etc., is one of the most appropriate resins.

The conductive resin layer preferably includes a thermosetting resin and a curing agent. When the epoxy resin is used as the base resin, the curing agent for the epoxy resin may be various known compounds such as phenol-based, amine-based, acid anhydride-based, imidazole-based, activated ester-based, and amide-imide-based compounds.

The thickest portion of the conductive resin layer is preferably, for example, about 3 μm or more and about 20 μm or less.

When the thin film layer is provided as the underlying electrode layer 32, the thin film layer is a layer of about 1 μm or less, for example, with metal particles deposited by a thin film forming method such as sputtering or vapor deposition.

The plating layers 34 are disposed to cover the underlying electrode layers 32. The plating layers 34 include the first plating layers 34a and the second plating layers 34b.

The first plating layers 34a are disposed to cover the first underlying electrode layers 32a. More specifically, the first plating layers 34a₁ to 34a₃ are disposed to cover the first underlying electrode layers 32a₁ to 32a₃.

The second plating layers 34b are disposed to cover the second underlying electrode layers 32b. More specifically, the second plating layers 34b₁ to 34b₃ are disposed to cover the second underlying electrode layers 32b₁ to 32b₃.

Each of the first plating layer 34a and the second plating layer 34b includes at least one selected from among, for example, Cu, Ni, Sn, Ag, Pd, Ag—Pd alloy, or Au.

The plating layer 34 may be a plurality of layers. In this case, the plating layer 34 preferably has a two-layer structure including a lower plating layer formed on the underlying electrode layer 32 and plated with Ni, and an upper plating layer on the lower plating layer and plated with Sn.

That is, the first plating layer 34a includes a first lower plating layer and a first upper plating layer located on the surface of the first lower plating layer.

The second plating layer 34b includes a second lower plating layer and a second upper plating layer located on the surface of the second lower plating layer.

The lower plating layer plated with Ni is used to prevent the underlying electrode layer 32 from being corroded by solder when the multi-unit multilayer ceramic capacitor 10 is mounted. The upper plating layer plated with Sn is used to easily mount the multi-unit multilayer ceramic capacitor 10 by improving the wettability of solder for mounting.

The thickness of one plating layer is preferably about 1 μm or more and about 10 μm or less, for example.

The dimension of the multi-unit multilayer ceramic capacitor 10 in the length direction z is a dimension L. The dimension L is preferably about 0.8 mm or more and about 14.4 mm or less, for example. The dimension L may be about 0.2 mm or more and about 20.0 mm or less, for example.

The dimension of the multi-unit multilayer ceramic capacitor 10 in the height direction y is a dimension T. The dimension T is preferably about 0.5 mm or more and about 0.8 mm or less, for example. The dimension T may be about 0.2 mm or more and about 1.0 mm or less, for example.

The dimension of the multi-unit multilayer ceramic capacitor 10 in the lamination direction x is a dimension W. The dimension W is preferably about 0.4 mm or more and about 7.8 mm or less, for example. The dimension W may be about 0.2 mm or more and about 20.0 mm or less, for example.

In the multi-unit multilayer ceramic capacitor 10 illustrated in FIG. 1, the inner electrode layer 16 is exposed only on the second principal surface 12d that is the surface adjacent to the mounting surface. Thus, the current path can be shortened, and therefore ESL (Equivalent Series Inductance) can be reduced compared with a general two-terminal capacitor in which inner electrode layers are exposed on both end surfaces.

In the multi-unit multilayer ceramic capacitor 10 illustrated in FIG. 1, the multilayer body 12 includes, inside the single element assembly, the capacitor unit 18 including the plurality of dielectric layers 14 and the plurality of inner electrode layers 16. Inside the multilayer body 12, the plurality of capacitor units 18 are positioned at predetermined intervals in the length direction z and the lamination direction x. Thus, the plurality of two-terminal capacitors can be replaced only with the multi-unit multilayer ceramic capacitor 10.

In the multi-unit multilayer ceramic capacitor 10 illustrated in FIG. 1, the number of capacitor units 18 disposed inside the multilayer body 12 of the multi-unit multilayer ceramic capacitor 10 is adjusted depending on disposition of land electrodes. Therefore, the disposition of the land electrodes for the general two-terminal capacitors can be used as it is without changing design.

In the multi-unit multilayer ceramic capacitor 10 illustrated in FIG. 1, the maximum dimension of the multilayer body 12 in the length direction z is larger than the dimension in the length direction z at the ½ position in the lamination direction x. Thus, the contact area between the mold resin and the multilayer body 12 increases during resin sealing with the mold resin, and therefore the fixing force of the mold resin to the multi-unit multilayer ceramic capacitor 10 can be improved.

Next, an example of a method for manufacturing the multi-unit multilayer ceramic capacitor is described. A method for manufacturing the multi-unit multilayer ceramic capacitor 10 is described below.

First, dielectric sheets for dielectric layers and conductive pastes for inner electrodes are prepared. The dielectric sheets and the conductive pastes for inner electrodes contain binders and solvents. Known binders and solvents may be used.

Next, the conductive pastes for inner electrodes are printed on the dielectric sheets in predetermined patterns by, for example, screen printing or gravure printing. Thus, dielectric sheets with the pattern of the first inner electrode layers and dielectric sheets with the pattern of the second inner electrode layers are prepared.

A portion serving as the plurality of capacitor units is formed by alternately laminating the dielectric sheets printed with the first inner electrode layers and the dielectric sheets printed with the second inner electrode layers to obtain a desired structure.

Next, a portion serving as the first outer layer portion 20a adjacent to the first side surface 12a is formed by laminating a predetermined number of dielectric sheets not printed with the patterns of the inner electrode layers. Then, the portion serving as the plurality of capacitor units 18 formed in the above step is laminated on the portion serving as the first outer layer portion 20a. Next, the intermediate layer 21 is formed by laminating a predetermined number of dielectric sheets not printed with the patterns of the inner electrode layers on the portion serving as the plurality of capacitor units 18. Then, a portion serving as a plurality of other capacitor units 18 formed in the above step is laminated on the intermediate layer 21. The layer including the capacitor units 18 and the intermediate layer 21 are repeatedly formed a predetermined number of times. Lastly, the second outer layer portion 20b adjacent to the second side surface 12b is formed by laminating a predetermined number of dielectric sheets not printed with the patterns of the inner electrode layers on the portion serving as the plurality of capacitor units 18. Thus, a multilayer sheet is produced.

Next, a multilayer block of the multi-unit multilayer ceramic capacitor is produced by pressing the multilayer sheet in the lamination direction by means of isostatic press, etc.

A large amount of resin is included in the dielectric sheets to be used for forming the first outer layer portion 20a and the second outer layer portion 20b such that the multilayer sheet can easily be stretched by the isostatic press. Thus, the protrusions 15a₁ to 15d₂ can be formed.

Next, the multilayer block is cut to a predetermined size, and therefore a multilayer chip is cut out. At this time, the corner portions and the ridge portions of the multilayer chip may be rounded by barrel finishing etc.

The multilayer body is produced by baking the multilayer chip thus cut out. The baking temperature is preferably about 900° C. or more and about 1400° C. or less, for example, depending on the materials of the dielectric layers 14 and the inner electrode layers 16.

Next, the first underlying electrode layers 32a of the plurality of first outer electrodes 30a and the second underlying electrode layers 32b of the plurality of second outer electrodes 30b are formed on the second principal surface 12d of the multilayer body 12 obtained by baking.

When a baked layer is formed as the underlying electrode layer 32, a conductive paste including a glass component and a metal component is applied and then baked. Thus, the baked layer is formed as the underlying electrode layer 32. At this time, the baking temperature is preferably about 700° C. or more and about 900° C. or less, for example. In this example embodiment, the underlying electrode layer 32 is the baked layer.

Various methods may be used as the method for forming the baked layer. For example, there may be used a method in which the direction of the multilayer body 12 is adjusted using a camera or magnet such that the second principal surface 12d is oriented downward, the multilayer body 12 is then held by a holding jig, and the conductive paste is applied by being ejected from a slit or hole. In the case of this method, the underlying electrode layer 32 can be formed not only on the second principal surface 12d but also up to a portion of the first side surface 12a and a portion of the second side surface 12b by increasing the ejection amount of the conductive paste.

A roller transfer method may be used for formation. When the underlying electrode layer 32 is formed not only on the second principal surface 12d but also up to a portion of the first side surface 12a and a portion of the second side surface 12b by the roller transfer method, the underlying electrode layer 32 can be formed up to a portion of the first side surface 12a and a portion of the second side surface 12b by increasing the pushing pressure during the roller transfer.

When a conductive resin layer is formed as the underlying electrode layer 32, the conductive resin layer can be formed by the following method. The conductive resin layer may be formed on the surface of a baked layer, or the conductive resin layer alone may be formed directly on the multilayer body 12 without the baked layer.

As the method for forming the conductive resin layer, a conductive resin paste including a thermosetting resin and a metal component is applied to the baked layer or the multilayer body 12, and the resin is thermally cured by heat treatment at a temperature of about 250° C. or more and about 550° C. or less, for example. Thus, the conductive resin layer is formed. At this time, the atmosphere during the heat treatment is preferably a N2 atmosphere. To prevent scattering of the resin and prevent oxidation of various metal components, the oxygen concentration is preferably about 100 ppm or less, for example.

The method for applying the conductive resin paste may be, for example, a method in which the conductive resin paste is applied by being ejected from a slit, as in the method for forming the baked layer as the underlying electrode layer 32.

When a thin film layer is formed as the underlying electrode layer 32, the underlying electrode layer 32 can be formed by carrying out masking, etc., and a thin film forming method such as sputtering or vapor deposition at the location where the outer electrode 30 is to be formed. The underlying electrode layer 32 formed from the thin film layer is a layer of about 1 μm or less, for example, with metal particles deposited.

Lastly, the plating layers 34 are formed. The plating layers 34 are formed on the surfaces of the underlying electrode layers 32. More specifically, a nickel plating layer serving as a lower plating layer and a tin plating layer serving as an upper plating layer are formed on the underlying electrode layer 32. The plating may be either electrolytic plating or non-electrolytic plating. However, the non-electrolytic plating is disadvantageous in that pretreatment using a catalyst, etc., is required to improve the plating precipitation rate, thereby complicating the steps. Thus, the electrolytic plating is preferably used in general.

In the manner described above, the multi-unit multilayer ceramic capacitor 10 according to this example embodiment is manufactured.

To check the effects of the multi-unit multilayer ceramic capacitors according to example embodiments of the present invention, experiments for checking whether chipping or cracking occurred and whether the mold resin entered was conducted by producing samples changed in distance d₁ between the line m connecting both protrusions at end portions of each sample and a central portion of each sample and samples changed in roundness amount of the protrusion as experimental samples based on the above manufacturing method.

Multi-unit multilayer ceramic capacitors were produced using the manufacturing method according to an example embodiment of the present invention with example design parameters described below.
Number of capacitor units included in multi-unit multilayer ceramic capacitor (N×M): 2× 2
Dimension of multi-unit multilayer ceramic capacitor in length direction: 2.25 mm
Dimension of multi-unit multilayer ceramic capacitor in lamination direction: 1.25 mm
Dimension of multi-unit multilayer ceramic capacitor in height direction: 0.45 mm
Thickness of dielectric layer: 0.50 μm
Thickness of inner electrode layer: 0.50 μm
Number of laminated layers: 400

Whether chipping or cracking occurred in each sample having undergone IR deterioration was checked on each sample after a moisture resistance load test. For the check, a digital microscope manufactured by Keyence Corporation (VHX-8000) was used.

The moisture resistance load test was checked as follows.

That is, the moisture resistance load test was conducted such that 4 V or less was kept for 144 hours at a temperature of 125° C. and a relative humidity of 95% R.H.

A warm bath manufactured by ESPEC Corporation (EHS-221M, EHS-222M) was used as the test bath. The number of products was 100 for each sample. When the moisture resistance reliability decreased due to chipping or cracking in any one of the 100 products, determination was made as “unsatisfactory.” The decrease in moisture resistance reliability was determined based on whether IR deterioration occurred.

The prepared samples of Sample Number 1 to Sample Number 3 were 0 μm, 2 μm, and 10 μm in terms of the distance d₁ between the line m connecting both the protrusions at the end portions of each sample and the central portion of each sample.

In each sample, the roundness amount was fixed to 20 μm.

The prepared samples of Sample Number 4 to Sample Number 6 were 1 μm, 10 μm, and 200 μm in terms of the roundness amount of the protrusion.

The distance d₁ between the line m connecting both the protrusions at the end portions of each sample and the central portion of each sample was fixed to 5 μm.

Table 1 shows results of the check on the presence or absence of a decrease in moisture resistance reliability due to chipping or cracking in relation to changes in distance d₁ between the line m connecting both the protrusions at the end portions of each sample and the central portion of each sample. Table 2 shows results of the check on the presence or absence of a decrease in moisture resistance reliability due to chipping or cracking in relation to changes in roundness amount of the protrusion.

TABLE 1

| | Distance d₁ between line m | Presence or absence of |
|---|---|---|
| | connecting both protrusions at end | decrease in moisture |
| Sample | portions of sample and central portion | resistance reliability due |
| number | of each sample (μm) | to chipping or cracking |
| 1 | 0 | x |
| 2 | 2 | ∘ |
| 3 | 10 | ∘ |

TABLE 2

| | | Presence or absence of decrease in |
|---|---|---|
| Sample | Roundness amount of | moisture resistance reliability due to |
| number | protrusion (μm) | chipping or cracking |
| 4 | 1 | x |
| 5 | 10 | ∘ |
| 6 | 200 | ∘ |

According to Table 1, the sample of Sample Number 1 was 0 μm in terms of the distance d₁ between the line m connecting both the protrusions at the end portions of the sample and the central portion of the sample. Therefore, the decrease in moisture resistance reliability due to chipping or cracking was observed.

The samples of Sample Number 2 and Sample Number 3 were 2 μm and 10 μm in terms of the distance d₁ between the line m connecting both the protrusions at the end portions of the sample and the central portion of the sample. Therefore, the decrease in moisture resistance reliability due to chipping or cracking was not observed.

According to Table 2, the sample of Sample Number 4 was 1 μm in terms of the roundness amount of the protrusion. Therefore, chipping or cracking occurred, and the decrease in moisture resistance reliability was observed.

The samples of Sample Number 5 and Sample Number 6 were 10 μm and 200 μm in terms of the roundness amount of the protrusion. Therefore, chipping or cracking did not occur, and the decrease in moisture resistance reliability was not observed.

Each sample was mounted on a board and sealed with a mold resin. Then, the sample with the mold resin was ground for a check on whether the mold resin entered the space between the board and the sample. For the check, a digital microscope manufactured by Keyence Corporation (VHX-8000) was used.

When the mold resin did not enter the space between the board and the sample, determination was made as “unsatisfactory.” The number of products was 100 for each sample.

The prepared samples of Sample Number 7 to Sample Number 9 were 0 μm, 2 μm, and 10 μm in terms of the distance d₁ between the line m connecting both the protrusions at the end portions of each sample and the central portion of each sample. Each prepared sample was sealed with a resin.

The roundness amount was fixed to 20 μm.

Table 3 shows results of the check on the presence or absence of entry of the mold resin into the space between the board and the sample in relation to changes in distance d₁ between the line m connecting both the protrusions at the end portions of each sample and the central portion of each sample.

TABLE 3

| | Distance d₁ between line m | Presence or absence of |
|---|---|---|
| | connecting both protrusions at end | entry of mold resin into |
| Sample | portions of sample and central portion | space between board and |
| number | of each sample (μm) | sample |
| 7 | 0 | x |
| 8 | 2 | ∘ |
| 9 | 10 | ∘ |

According to Table 3, the sample of Sample Number 7 was 0 μm in terms of the distance d₁ between the line m connecting both the protrusions at the end portions of the sample and the central portion of the sample. In this case, it was observed that the mold resin did not enter and the improvement in fixing force was not achieved.

The samples of Sample Number 8 and Sample Number 9 were 2 μm and 10 μm in terms of the distance d₁ between the line m connecting both the protrusions at the end portions of the sample and the central portion of the sample. In this case, it was observed that the mold resin entered the space between the board and the sample and the improvement in fixing force between the board and the sample was expected.

From the results of the above experiment, the following effects were observed.

When the distance d₁ between the line m connecting both the protrusions at the end portions of the sample and the central portion of the sample was 2 μm or 10 μm, it was observed that the decrease in moisture resistance reliability due to chipping or cracking was suppressed.

When the roundness amount of the protrusion was 10 μm or 200 μm, it was observed that the reliability was improved by the suppression of chipping or cracking.

When the distance d₁ between the line m connecting both the protrusions at the end portions of the sample and the central portion of the sample was 2 μm or 10 μm, it was observed that the mold resin easily entered the gap between the sample and the board during the sealing with the mold resin, and the improvement in fixing force was expected.

Although example embodiments of the present invention are disclosed in the above description, the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multi-unit multilayer ceramic capacitor comprising:
a multilayer body including a first side surface and a second side surface that face each other in a lamination direction, a first principal surface and a second principal surface that face each other in a height direction perpendicular or substantially perpendicular to the lamination direction, and a first end surface and a second end surface that face each other in a length direction perpendicular or substantially perpendicular to both the lamination direction and the height direction;
a first outer electrode extending in the lamination direction on the second principal surface; and
a second outer electrode extending in the lamination direction on the second principal surface; wherein
the multilayer body includes, inside a single element assembly, a plurality of capacitor units each including a plurality of dielectric layers and a plurality of inner electrode layers, the plurality of capacitor units being positioned at predetermined intervals in the length direction and the lamination direction;
the inner electrode layers include:
first inner electrode layers connected to the first outer electrode; and
second inner electrode layers connected to the second outer electrode;
each of the first inner electrode layers includes:
a first counter electrode portion; and
a first extended portion protruding toward the first outer electrode;
each of the second inner electrode layers includes:
a second counter electrode portion; and
a second extended portion protruding toward the second outer electrode; and
a maximum dimension of the multilayer body in the height direction is larger than a dimension in the height direction at a ½ position in the lamination direction.

2. The multi-unit multilayer ceramic capacitor according to claim 1, wherein
the first principal surface includes a protrusion that protrudes in the height direction along an end edge adjacent to the first side surface, and a protrusion that protrudes in the height direction along an end edge adjacent to the second side surface, and the first principal surface is recessed when viewed from the second end surface; and
the second principal surface includes a protrusion that protrudes in the height direction along an end edge adjacent to the first side surface, and a protrusion that protrudes in the height direction along an end edge adjacent to the second side surface, and the second principal surface is recessed when viewed from the second end surface.

3. The multi-unit multilayer ceramic capacitor according to claim 1, wherein
when the first principal surface is viewed from the second end surface, a distance between a point at the ½ position in the lamination direction and a line connecting a maximum point of a protrusion provided along the first side surface and a maximum point of a protrusion provided along the second side surface is about 2 μm or more; and
when the second principal surface is viewed from the second end surface, a distance between a point at the ½ position in the lamination direction and a line connecting a maximum point of a protrusion provided along the first side surface and a maximum point of a protrusion provided along the second side surface is about 2 μm or more.

4. The multi-unit multilayer ceramic capacitor according to claim 1, wherein a maximum dimension of the multilayer body in the length direction is larger than a dimension in the length direction at the ½ position in the lamination direction.

5. The multi-unit multilayer ceramic capacitor according to claim 1, wherein
the first end surface includes a protrusion that protrudes in the length direction along an end edge adjacent to the first side surface, and a protrusion that protrudes in the length direction along an end edge adjacent to the second side surface, and the first end surface is recessed when viewed from the second principal surface; and
the second end surface includes a protrusion that protrudes in the length direction along an end edge adjacent to the first side surface, and a protrusion that protrudes in the length direction along an end edge adjacent to the second side surface, and the second end surface is recessed when viewed from the second principal surface.

6. The multi-unit multilayer ceramic capacitor according to claim 1, wherein
when the first end surface is viewed from the second principal surface, a distance between a point at the ½ position in the lamination direction and a line connecting a maximum point of a protrusion provided to an end edge adjacent to the first side surface and a maximum point of a protrusion provided to an end edge adjacent to the second side surface is 2 μm or more; and
when the second end surface is viewed from the second principal surface, a distance between a point at the ½ position in the lamination direction and a line connecting a maximum point of a protrusion provided to an end edge adjacent to the first side surface and a maximum point of a protrusion provided to an end edge adjacent to the second side surface is about 2 μm or more.

7. The multi-unit multilayer ceramic capacitor according to claim 1, wherein a roundness amount that is a curvature radius of a corner portion of the multilayer body is about 10 μm or more and about 200 μm or less.

8. The multi-unit multilayer ceramic capacitor according to claim 1, wherein
the multilayer body includes the plurality of capacitor units such that N capacitor units are positioned at the predetermined intervals in the length direction and M capacitor units are positioned at the predetermined intervals in the lamination direction; and
one of the following conditions is satisfied:
$$1 \leq N \leq 12 and 2 \leq M \leq 12 ; and$$
$$2 \leq N \leq 12 and 1 \leq M \leq 12.$$

9. The multi-unit multilayer ceramic capacitor according to claim 1, wherein the dimension of the multilayer body in the height direction is about 1.00 mm or less.

10. The multi-unit multilayer ceramic capacitor according to claim 1, wherein the multilayer body has a rectangular or substantially rectangular parallelepiped shape.

11. The multi-unit multilayer ceramic capacitor according to claim 1, wherein the multilayer body includes rounded corner portions and rounded ridge portions.

12. The multi-unit multilayer ceramic capacitor according to claim 1, further comprising intermediate layers between the plurality of capacitor units.

13. The multi-unit multilayer ceramic capacitor according to claim 1, wherein gaps are provided between the plurality of capacitor units.

14. The multi-unit multilayer ceramic capacitor according to claim 1, wherein each of the plurality of capacitor units have a same structure.

15. The multi-unit multilayer ceramic capacitor according to claim 1, wherein a Sn layer is provided between one of the dielectric layers and each of the first and second inner electrode layers in each of the plurality of capacitor units.

16. The multi-unit multilayer ceramic capacitor according to claim 1, wherein each of the first and second outer electrodes includes an underlying electrode layer on a surface of the multilayer body and a plating layer on the underlying electrode layer.

17. The multi-unit multilayer ceramic capacitor according to claim 16, wherein the underlying electrode layer is a baked layer, a conductive resin layer, or a thin film layer.

18. The multi-unit multilayer ceramic capacitor according to claim 16, wherein the plating layer includes Cu, Ni, Sn, Ag, Pd, an Ag—Pd alloy, or Au.

19. The multi-unit multilayer ceramic capacitor according to claim 1, wherein a dimension of the multi-unit multilayer ceramic capacitor in the length direction is about 0.8 mm or more and about 14.4 mm or less, a dimension of the multi-unit multilayer ceramic capacitor in the height direction is about 0.5 mm or more and about 0.8 mm or less, and a dimension of the multi-unit multilayer ceramic capacitor in the lamination direction is about 0.4 mm or more and about 7.8 mm or less.

20. The multi-unit multilayer ceramic capacitor according to claim 1, wherein a dimension of the multi-unit multilayer ceramic capacitor in the length direction is about 0.2 mm or more and about 20.0 mm or less, a dimension of the multi-unit multilayer ceramic capacitor in the height direction is about 0.2 mm or more and about 1.0 mm or less, and a dimension of the multi-unit multilayer ceramic capacitor in the lamination direction is about 0.2 mm or more and about 20.0 mm or less.
